(19) United States
(12) Patent Application Publication
(10) Pub. No.: US 2006/0051661 A1
(43) Pub. Date: Mar. 9, 2006

(54) Diffusion stabilized gas barriers

(76) Inventor: G.B.Kirby Meacham, Shaker Heights, OH (US)

Correspondence Address: EDWARDS & ANGELL, LLP, P.O. BOX 55874, BOSTON, MA, 02205, US

(21) Appl. No.: 10/535,162

(22) PCT Filed: Nov. 14, 2003
(86) PCT No.: PCT/US03/36199

§ 371 Date: May 16, 2005

Related U.S. Application Data
(60) Provisional application No. 60/426,637, filed on Nov. 16, 2002.

(51) Int. Cl. H01M 2/14

(52) U.S. Cl. 429/129

(57) ABSTRACT

A metallic barrier (1) and a method for separating fuel (5) and oxidant (6) gases are disclosed for use in high temperature systems such as solid oxide fuel cells (SOFC) or cell stacks. The metallic barrier (1) can be formed as a metallic bipolar separator plate or a seal, without requiring the use of chromium alloys or noble metals. Controlled diffusion of fuel gas (5) through the metallic barrier (1) limits the thickness of an adherent electronically insulating oxide layer (4) on an opposing surface in contact with oxidant gas (6). This stabilized oxide layer may be penetrated by refractory conductive particles such as doped lanthanum chromite to provide multiple electronically conductive paths through the oxide layer and the metallic barrier.

### CROSS-REFERENCE TO RELATED APPLICATION

The present invention claims priority of U.S. Provisional Application 60/426,637, filed Nov. 16, 2002, the disclosure of which is incorporated herein by reference.

### FIELD OF THE INVENTION

The present invention is directed to barriers that separate fuel and oxidant gases in high temperature solid oxide fuel cells (SOFC) and cell stacks, and more particularly relates to the use of controlled diffusion of fuel gas to protect metallic barrier structures from excessive oxidation.

### BACKGROUND OF THE INVENTION

It is generally known to provide bipolar separators and seals that separate fuel and oxidant gases in SOFC systems.

Fuel cells are well known electrochemical systems that generate electrical current by chemically reacting a fuel gas and an oxidant gas on the surfaces of electrodes. Conventionally, the oxidant gas is oxygen or air, and in high temperature (600° C. to 1000° C.) SOFC the fuel gas is hydrogen or a mixture of hydrogen, carbon monoxide, and traces of hydrocarbons. The fuel gas may also contain non-fuel gases including nitrogen, water vapor and carbon dioxide. Each cell produces a potential of less than 1 volt, so multiple cells are typically connected in series to produce a higher, more useful voltage. The series interconnection is often accomplished by constructing a bipolar stack of planar cells such that current flows from the anode of one cell to the cathode of the next cell. The stack output current is collected from the top and bottom cells at a voltage equal to the sum of the voltages of the individual cells. Fuel gas and the oxidant gas must be supplied to each cell in the stack, while being kept separate so that they do not react with each other except on the surfaces of the electrodes. Direct reactions cause a loss in energy conversion efficiency, and may generate high temperatures that damage the cell or stack structures. Barrier structures that separate fuel gas and oxidant gas are therefore required elements in fuel cell stacks. Two types of barriers exemplify these structures: bipolar separator plates and seal gaskets.

A bipolar separator connects the anode of each cell in a stack to the cathode of an adjacent cell. These bipolar separators are in contact with the fuel gas on the anode side and the oxidant gas on the cathode side, and must be largely impermeable to these gases. In addition, they must be electronic conductors able to carry the current from one cell to the next. Further, they must be ionic non-conductors to avoid unwanted reactions between the fuel and oxidant gases. Finally, they must not deteriorate from interactions with the fuel and oxidant gases at the elevated operating temperatures, and must have thermal expansion characteristics compatible with adjacent cells.

Platinum is an elemental metal that has a unique combination of high temperature oxidation resistance, low vapor pressure, low gas permeability, compatible thermal expansion and electronic conductivity. It exemplifies a good bipolar separator material, but the cost is prohibitive for most applications.

A number of other metals and alloys have been investigated as lower cost alternatives. In general, pure metals and alloys that resist oxidation damage do so by forming an adherent oxide layer that is a barrier to further oxygen attack. While the oxide layer protects the bulk metal, oxides are generally electronic insulators and tend to severely restrict current flow. Chromium alloys, such as high chromium ferric steel, are an exception, and form an electronically conductive, adherent oxide. An example is iron with 18% chromium and 1% aluminum. Chromium alloys, however, form volatile chromium compounds in an oxidizing environment at SOFC operating temperatures. These compounds migrate and degrade other cell components, particularly the cathode-electrolyte interface, e.g., as described in U.S. Pat. No. 6,444,340 (Jaffrey) and U.S. Pat. No. 5,942,349 (Badwal et al.). Jaffrey eliminates chromium, and instead uses noble metal conductors between the cathode and anode sides of a nonconductive bipolar separator to form the electrical interconnection. U.S. Pat. No. 6,183,897 (Hartvigsen et al.) follows a related approach. Badwal et al. apply a coating to the cathode side of a chromium-containing bipolar separator that captures and sequesters chromium-containing vapor. U.S. Pat. No. 6,280,868 (Badwal et al.) describes nickel and chromium interdiffusion and oxidation problems on the anode side of a chromium-containing bipolar separator, and applies one or more noble metal layers as a protective barrier. In summary, these references indicate that chromium alloy bipolar separators should not be used in bipolar separator plates.

Doped lanthanum chromite provides a nonmetallic alternative. It is an electronically conductive, ionically non-conductive relatively impermeable ceramic. It is compatible with the fuel and oxidant gases, does not evolve chromium vapors, and has favorable expansion properties. It has been used successfully as a bipolar separator in the form of self-supporting separator plates made from bulk material and as thin films applied to cathode surfaces. U.S. Pat. No. 5,958,304 (Khandkar et al.) discloses examples of formulations and processes for making self-supporting doped lanthanum-chromite separator plates. Such plates function well, but the cost, weight and volume are high.

Thin (30 to 100 micron) doped lanthanum chromite films applied to the cathode are a potential improvement. Application methods include electrochemical vapor deposition (EVD) and plasma spray with high temperature heat treatment to reduce porosity. These methods are described, e.g., in U.S. Pat. No. 5,391,440 (Kuo et al.), and involve processing steps at 1350° C. to 1450° C. that are time-consuming and expensive. Further, these high firing temperatures may damage other components, limiting their use in fabrication approaches where multiple cell components are combined green and co-fired. Further, the range of compositions that can be applied by EVD is limited, resulting in non-optimum thermal expansion and conductivity.

Seal gaskets are similar to bipolar separators in that they also form barriers between fuel and oxidant gases. Seal gaskets are somewhat compliant planar structures that are penetrated by one or more openings, and are clamped in gaps between stack components. The compliance allows the seal gaskets to conform to the mating surfaces to form a barrier to gas flow through the gaps. Gaskets block flow between internal openings and the exterior edge of the gasket, and from one internal opening to another. Some surfaces contact fuel gas, and other surfaces contact oxidant gas, resulting in requirements similar to bipolar separators. They must be ionic non-conductors, and largely impermeable to the fuel and oxidant gases. Further, they must not deteriorate from interactions with the fuel and oxidant gases at the elevated operating temperatures, and must have thermal expansion characteristics compatible with the adjacent cells. The difference is that they do not necessarily need to be electronic conductors.

Glass-based seal gaskets are described and discussed, e.g., in U.S. Pat. No. 5,453,331 (Bloom et al.) and U.S. Pat. No. 6,271,158 (Xue et al.). The glass and filler are selected such that the seal is somewhat viscous and compliant at the cell operating temperature, thereby adjusting to fill the gaps. This approach suffers from at least three drawbacks, however. One problem is that the seals transition to elastic solids as the cell and stack assembly cools. This may generate significant stresses unless the solids are a good thermal expansion match with the cell and stack components. A second problem is that glasses often wet the cell and stack materials, and therefore migrate from their original locations. A third problem is that the glasses tend to interdiffuse with the cell materials, changing the properties of both substances.

U.S. Pat. No. 6,106,967 (Virkar et al.) addresses the problems of glass seals by employing a thin metallic foil as a combined bipolar separator and sealing gasket. The thin metallic foil of Virkar et al. is compliant enough in compression to conform to the mating surfaces and provide a seal. Further, it is thin enough and does not generate excessive thermal stresses even with some mismatch in thermal expansion characteristics. Virkar et al. indicate that the foil should be a superalloy containing chromium, which should be avoided due to the difficulties with chromium as discussed above.

In conclusion, the prior art does not describe SOFC bipolar separator and seal designs that combine all the technical and cost characteristics required for durable, economically competitive fuel cell power generation systems.

### SUMMARY OF THE INVENTION

The present invention is directed to a method for separating fuel and oxidant gases in high temperature systems, and metallic barriers such as bipolar separators and seals useful in carrying out the method. These metallic barriers preferably are implemented in high temperature solid oxide fuel cells (SOFC), cell stacks, and related structures. The metallic barriers can be produced without using chromium alloys or costly noble metals.

According to one aspect of the invention, a metallic barrier can provide protection by enabling formation of adherent oxide layers. Preferred metals such as nickel, cobalt and copper form these adherent, protective oxide layers on the surfaces exposed to oxidant gases, and remain in the reduced, metallic state on the surfaces exposed to the fuel gases. The selected geometry allows a small quantity of hydrogen from the fuel gas to diffuse through the bulk metal to the metal-metal oxide interface on the other side. Here, the hydrogen is ionized instead of the less active metal, and directly or indirectly combines with oxygen to form water vapor. This stops the metal oxidation process, and limits the oxide film growth to an equilibrium thickness set by the hydrogen diffusion rate from one side, and the effective oxygen diffusion rate from the other side. A small quantity of hydrogen is thereby consumed as a sacrificial element to maintain the metal barrier integrity.

According to another aspect of the invention, stable electrically conductive paths are provided through the insulating oxide film. These may be particles of refractory electronically conductive material such as doped lanthanum chromite that form a plurality of electronically conducting paths from the outside surface of the oxide layer to the conductive barrier metal. Such electronically conducting paths, also referred to herein as “microvias,” allow current flow from the surfaces contacted by the oxidant gases to the surfaces contacted by fuel gases. The diffusion of hydrogen helps maintain this structure. The refractory conductive particles shield the underlying metal from oxygen diffusion, and thereby enhance the ability of the diffusing hydrogen to maintain the contacting metal barrier material in a conductive metallic state. Penetrating particles may serve other purposes. Electronically insulating refractory particles, for example, may provide properties such as reduced oxygen diffusion. This has applications for seal barriers that do not carry current.

The invention may be implemented in several ways. For example, a bipolar separator may be formed by the following steps. First, a doped lanthanum chromite film is applied to a doped lanthanum manganite cathode by plasma spraying. The film is composed of flattened droplets bonded to the cathode, with voids between the droplets. Second, a metal barrier layer is applied over the lanthanum chromite film by a process such as sputter deposition that forms a non-porous metallic layer, and bonds to the exposed surfaces of the lanthanum chromite particles. In service, the metal is oxidized in areas facing the voids between the lanthanum chromite particles, but is otherwise protected by the shielding effect of the lanthanum chromite particles and the reducing action of the hydrogen diffusing through the metal. A different form of bipolar separator may be formed by plasma spraying a metal foil with a doped lanthanum chromite film such that the flattened lanthanum chromite particles are intimately bonded to the metal. Again, the metal is oxidized in areas facing the voids between the lanthanum chromite particles, but is otherwise protected by the shielding effect of the lanthanum chromite particles and the reducing action of the hydrogen diffusing through the metal. In both cases a stable conductive barrier is formed between the fuel gases and the oxidant gases, without the requirement for a continuous, void-free lanthanum chromite film. This simplifies the manufacturing process and eliminates high temperature sintering steps. Unlike continuous ceramic films, it forms in a ductile barrier. The lanthanum chromite particles do not form a continuous film, and the metal oxide film between the particles will heal after distortion.

Component geometry is important in both the bipolar separator and seal embodiments of the invention. Flow paths and diffusion path lengths must be chosen to assure on the one hand that sufficient hydrogen reaches the oxide layer to stabilize its location, while on the other hand avoiding excessive and uneconomic consumption of fuel.

The present invention can provide at least the following benefits. First, it stabilizes low-cost, ductile metal structures that serve as barriers between fuel and air gases through controlled diffusion of hydrogen in the bulk metal of the structure. Second, it provides electrically conductive surface layers without chromium alloys and the attendant problems. Third, it utilizes porous sprayed lanthanum chromite films to form robust, ductile barriers rather than fragile, brittle films.

### BRIEF DESCRIPTION OF THE DRAWINGS

The appended claims set forth those novel features that characterize the invention. However, the invention itself, as well as further objects and advantages thereof, will best be understood by reference to the following detailed description of preferred embodiments. The accompanying drawings, where like reference characters identify like elements throughout the various figures, in which:

FIG. 1 illustrates a dynamic balance between fuel diffusion and oxygen diffusion in a dynamically stabilized metallic barrier according to the present invention;

FIGS. 2A and 2B illustrate a deposited metal film bipolar separator embodying the invention;

FIGS. 3A and 3B illustrate a metallic foil bipolar separator embodying the invention; and

FIG. 4 illustrates a seal embodying the invention.

### DETAILED DESCRIPTION OF THE INVENTION

Upon examination of the following detailed description the novel features of the present invention will become apparent to those of ordinary skill in the art or can be learned by practice of the present invention. It should be understood that the detailed description of the invention and the specific examples presented, while indicating certain embodiments of the present invention, are provided for illustration purposes only. Various changes and modifications within the spirit and scope of the invention will become apparent to those of ordinary skill in the art upon examination of the following detailed description of the invention and claims that follow.

The present invention relates to barriers that separate fuel and oxidant gases in high temperature systems. The invention is described with respect to high temperature solid oxide fuel cells (SOFC) and cell stacks operating with air and hydrogen-containing fuel gas. However, it will be apparent to those skilled in the art that the following detailed description is similarly applicable to other types of high temperature systems. Examples include molten carbonate fuel cells, and fuel processors that require barriers and seals between reducing and oxidizing substances.

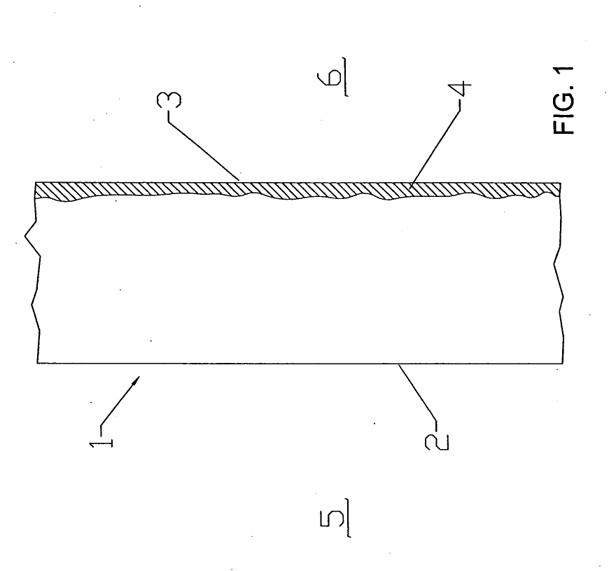

FIG. 1 illustrates a metallic barrier useful in the present invention, where the metallic barrier (e.g., in the form of a metallic plate) preferably provides a dynamic balance between fuel diffusion and oxygen diffusion. As shown in FIG. 1, a metallic plate 1 is exposed to hydrogen-containing fuel gas 5 on a first surface 2 of the metallic plate 1, and is exposed to oxidant gas 6 on a second surface 3 of the metallic plate 1. An adherent oxide layer 4 can be formed on the second surface 3. Without fuel gas present, the oxide layer tends to grow thicker over time through a combination of oxygen diffusion inward (toward the metallic plate 1) and metal ion diffusion outward through the oxide layer 4. A metal such as nickel forms a metal-deficient oxide that contains vacancies at metal sites in a crystal lattice. The vacancy concentration increases toward the metal-metal oxide interface because of the presence of oxygen in the air, and the concentration gradient decreases as the oxide layer grows thicker. Metal ions migrate to the metal-metal oxide interface by hopping from metal vacancy to metal vacancy under the influence of the vacancy concentration gradient. As used herein, the “metal-metal oxide interface” is defined as a region in which the oxide layer 4 contacts the metallic plate 1. With the fuel gas 5 present on the other side of the metallic plate 1, hydrogen diffuses through the metallic plate 1 to the metal-metal oxide interface.

In practice, the hydrogen contained in the fuel gas 5 diffuses through the metallic plate 1 as monatomic hydrogen. The monatomic hydrogen loses electrons more easily than a relatively noble metal such as nickel in electron-deficient oxidizing environments. As a result, the hydrogen sacrificially ionizes to satisfy the electron deficiency, forming protons and leaving the metal of the metallic plate 1 unchanged. The protons migrate to the metal-metal oxide interface by hopping from metal vacancy to metal vacancy, and combine with oxygen to form water vapor that escapes into the air. Under steady-state conditions, an equilibrium metal oxide layer thickness is reached. This equilibrium thickness is a function of the fuel gas 5 and oxidant gas 6 composition and pressures, metal function of the vacancy migration rate and the hydrogen diffusion rates through the metallic plate 1. The oxide layer is expected to be thin compared to the metal layer, since hydrogen diffuses more rapidly in metal than vacancies in the oxide layer. If operating conditions shift to favor a thicker oxide layer, metal is oxidized and transported to the surface. If operating conditions shift to favor a thinner oxide layer, then oxide at the metal-metal oxide interface is reduced to metal, forming water vapor. The water vapor then diffuses through the oxide layer along grain boundaries and through pores.

The metallic plate 1 may be selected from a variety of elemental metals, alloys, and cermets containing ceramic particles in a metallic matrix. It may also be a layered structure in which the composition changes through the thickness of the plate. The metallic plate 1 should be suitably capable of forming an adherent oxide layer having a higher resistance to oxidation than hydrogen. Nickel and copper are examples of elemental metals with these characteristics.

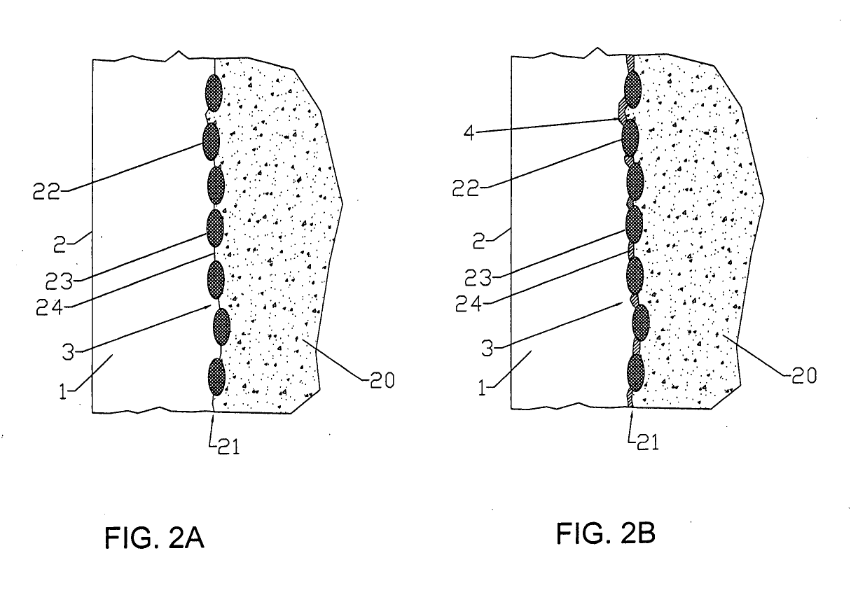

FIG. 2A shows a deposited metal film bipolar separator embodying the invention as fabricated before it is put in service. The substrate 20 is a porous SOFC cathode, which can be made of doped lanthanum manganite, for example. An electronically conductive porous refractory layer 21, which can be made of doped lanthanum chromite, for example, is applied to the substrate 20 by plasma spraying or another suitable technique, such that particles 22 comprising the layer 21 preferably are in conductive contact with the substrate. The metallic plate 1 is formed over the porous layer 21 by a deposition process such as sputtering that provides a dense metallic layer. Plate 1 has a free first surface 2 and an opposite second surface 3 contacting the porous layer 21. The second surface 3 is divided into areas 23 that are bonded to the particles 22 and areas 24 that bridge gaps between the particles 22.

FIG. 2B shows the metal film bipolar separator of FIG. 2A during service at high temperature with fuel gas contacting surface 2 and oxidant gas contacting surface 3 (see, e.g., fuel gas 5 and oxidant gas 6 of FIG. 1). This results in the formation of an adherent oxide layer 4 on areas 24 that are in contact with the oxidant gas. The areas 23 are shielded from the oxidant gas by the particles 22, and hydrogen diffusing into the plate 1 from the first surface 2 limits the penetration of the oxide layer 4 into the areas 23. This assures that metallic contact and electronic conductivity are maintained near approximately the centers of the areas 23 over a range of conditions. The porous layer 21 also has the effect of reducing the oxygen diffusion of the system, since only the areas 24 contribute to the oxygen diffusion area. This reduces the amount of hydrogen that must be used to maintain the metallic structure.

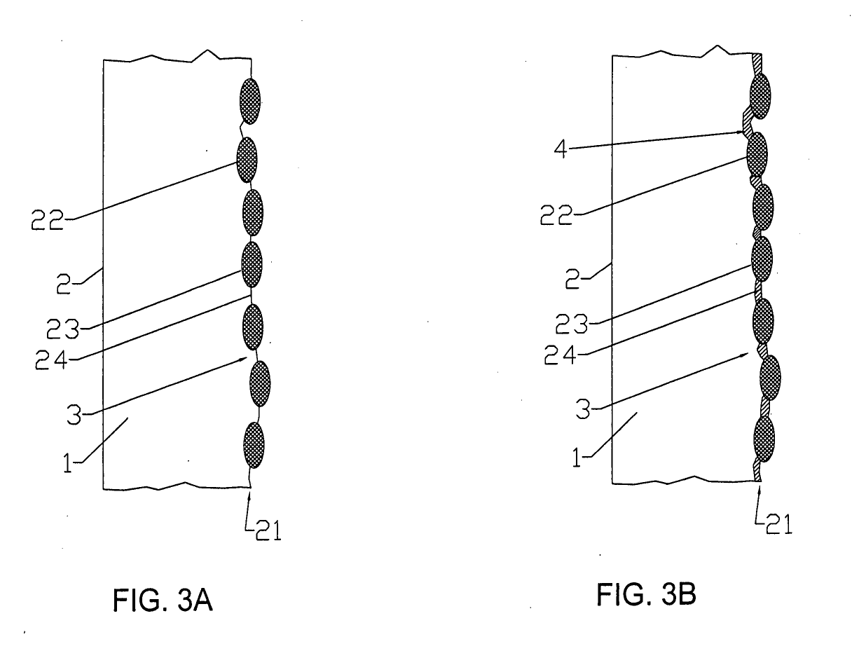

FIG. 3A shows a metal foil or plate bipolar separator embodying the invention as fabricated before it is put in service. The substrate is the metal foil or plate 1. An electronically conductive porous refractory layer 21, which can be made of doped lanthanum chromite, for example, is applied to the plate 1 by plasma spraying or another suitable technique such that particles 22 comprising the layer 21 preferably are in close conductive contact with the plate. The plate 1 has a free first surface 2 and an opposite second surface 3 contacting the porous layer 21. The second surface 3 is divided into areas 23 that are bonded to the particles 22 and areas 24 that bridge the gaps between the particles 22.

FIG. 3B shows the system of FIG. 3A during service at high temperature with fuel gas contacting surface 2 and oxidant gas contacting surface 3. As in the metal film bipolar separator of FIGS. 2A and 2B, this results in the formation of an adherent oxide layer 4 on areas 24 that are in contact with the oxidant gas. The areas 23 are shielded from the oxidant gas by the particles 22, and hydrogen diffusing into the plate 1 from the first surface 2 limits the penetration of the oxide layer 4 into the areas 23. This assures that metallic contact and electronic conductivity are maintained near approximately the centers of the areas 23 over a range of conditions. The porous layer 21 also has the effect of reducing the oxygen diffusion of the system, since only the areas 24 contribute to the oxygen diffusion area. This reduces the amount of hydrogen that must be used to maintain the metallic structure.

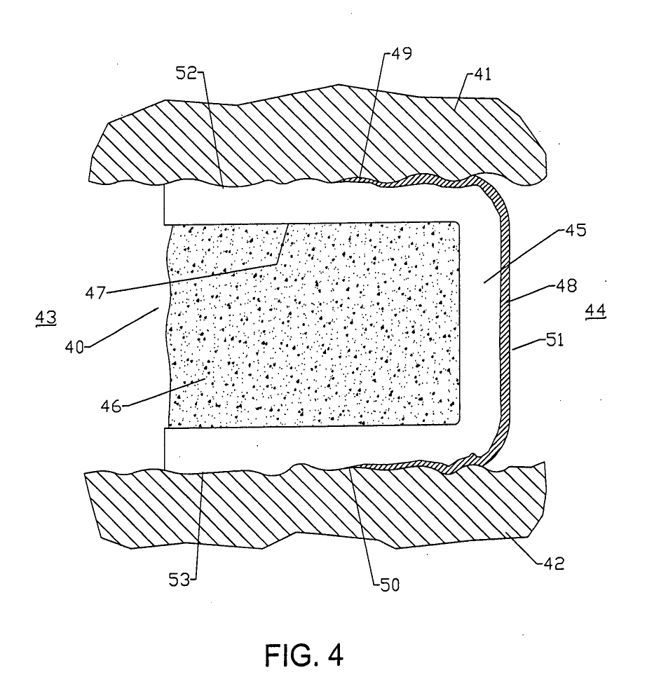

FIG. 4 illustrates a seal 40 according to the invention. The seal 40 is clamped between first and second members 41 and 42, respectively, thereby separating fuel gas in region 43 from oxidant gas in region 44. The seal 40 includes a metal shell 45 preferably covering approximately three sides of a porous core 46, the porous core 46 being arranged such that fuel gas contacts an open fourth side thereof. The porous core 46 preferably allows the fuel gas to contact an inside 47 of the metal shell 45. The clamping force applied by the first and second members 41 and 42 can deform the surface of the metal shell 45, forming barrier zones 49 and 50 between the fuel and oxidant gases in regions 43 and 44, respectively. The oxidant gas contacts an exposed outside surface 51 of the metal shell 45, forming an oxide layer 48. The hydrogen from the fuel cell region 43 which contacts the inside 47 of the metal shell 45 diffuses into the metal of the metal shell 45, thereby limiting the penetration of the oxide layer 48. Oxygen cannot effectively form an oxide layer on portions 52 and 53 of the metal shell 45, because oxidant gas contact is blocked by the barrier zones 49 and 50, and the reducing action of the hydrogen dominates. This results in the formation of transition regions near the barrier zones 49 and 50 where the oxide layer 48 thins and vanishes.

The overall effect is that the seal 40 is a metal barrier that is maintained in a compliant, metallic state by the diffusion of a small amount of hydrogen that limits the oxide layer growth. The metal shell 45 may be selected from a variety of elemental metals, alloys, and cermets containing ceramic particles in a metallic matrix. It may also be a layered structure in which the composition changes as a function of the thickness of the metal shell 45. Preferably the selected material of the metal shell 45 is capable of forming an adherent oxide layer and has a higher resistance to oxidation than hydrogen. Nickel and copper are examples of elemental metals with these characteristics. The porous core 46 may be any material stable in a high temperature fuel gas environment that allows the passage of gas, and provides the desired levels of compliance and support. The porous core 45 can be omitted in cases where the metal shell 45 is self-supporting to the extent that the required gas access is maintained. More broadly, any configuration of metal shell 45 that contains internal passages or porosity that bring fuel gas within diffusion distance of the oxide layer is within the scope of the invention. Coatings, including conductive or non-conductive refractory particles that reduce the oxygen diffusion area through the surfaces exposed to oxidant gas, are also within the scope of the invention.

The foregoing embodiments of the present invention have been presented for the purposes of illustration and description. These descriptions and embodiments are not intended to be exhaustive or to limit the invention to the precise form disclosed, and obviously many modifications and variations are possible in the light of the above disclosure. The embodiments were chosen and described in order to best explain the principle of the invention and its practical applications to thereby enable others skilled in the art to best utilize the invention in its various embodiment and with various modifications as are suited to the particular use contemplated. It intended that the invention be defined by the following claims. The term “refractory” is used in the claims to designate solid materials that remain unaffected by oxidant and fuel gases at elevated temperatures.

What is claimed is:

1. A metallic barrier for separating fuel gas from oxidant gas, comprising:
a metallic plate having first and second surfaces, the fuel gas being exposed to the first surface and the oxidant gas being exposed to the second surface;
an adherent oxide layer formed on the second surface at a metal-metal oxide interface; and
a portion of the fuel gas diffusing into the metallic plate from the first surface, the portion of fuel gas modifying an oxidation environment at the metal-metal oxide interface to dynamically stabilize a thickness of the adherent oxide layer.

2. The metallic barrier of claim 1, wherein a diffusion path length between the first and second surfaces is selected such that the portion of fuel gas reaches the metal-metal oxide interface.

3. The metallic barrier of claim 1, wherein at least one refractory particle extends through the thickness of the stabilized oxide layer.

4. The metallic barrier of claim 3, wherein the refractory particle is electronically conductive, such that a continuous electronically conductive path is formed between the first and second surfaces.

5. The metallic barrier of claim 4, wherein the electronically conductive refractory particle is doped lanthanum chromite.

6. The metallic barrier of claim 3, wherein the refractory particle reduces a diffusion area of the stabilized oxide layer.

7. The metallic barrier of claim 6, wherein the refractory particle has lower diffusivity than the oxide layer so as to reduce the total diffusion.

8. A fuel cell bipolar separator, comprising:
a metallic plate having first and second surfaces, the fuel gas being exposed to the first surface and the oxidant gas being exposed to the second surface;
a porous layer of electronically conductive refractory particles in electrical contact with the second surface;
an adherent oxide layer formed on the second surface between the refractory particles, the refractory particles constituting electronically conductive paths through the adherent oxide layer to the metallic plate; and
a portion of the fuel gas diffusing into the metallic plate from the first surface, the portion of fuel gas modifying an oxidation environment at the metal-metal oxide interface to dynamically stabilize a thickness of the adherent oxide layer.

9. The fuel cell bipolar separator of claim 8, further including a substrate for receiving the porous layer.

10. The fuel cell bipolar separator of claim 9, wherein the electronically conductive refractory particles of the porous layer are applied to the substrate by a thermal spraying process.

11. The fuel cell bipolar separator of claim 8, wherein the electronically conductive refractory particles are composed of doped lanthanum chromite.

12. The fuel cell bipolar separator of claim 8, wherein the metallic plate is formed by spraying dense metal over the porous layer.

13. The fuel cell bipolar separator of claim 8, wherein the metallic plate is applied by a thin film deposition process.

14. The fuel cell bipolar separator of claim 8, wherein the metallic plate is a metal foil.

15. A seal incorporating a metallic barrier, the seal being positioned between first and second members and exposed to fuel gas on one side of the metallic barrier and oxidant gas on the other side of the metallic barrier, comprising:
a hollow metallic structure having at least an open side, a closed side, and an interior, the interior being fluidly connected to the fuel gas;
a metallic plate formed as part of the hollow metallic structure, the metallic plate having first and second surfaces, where the first surface is exposed to the fuel gas through the interior of the hollow metallic structure and the second surface is exposed to the oxidant gas;
an adherent oxide layer formed on the second surface at a metal-metal oxide interface; and
a portion of the fuel gas diffusing into the metallic plate from the first surface, the portion of fuel gas modifying an oxidation environment at the metal-metal oxide interface to dynamically stabilize a thickness of the adherent oxide layer.

16. The seal of claim 15, wherein an interior of the hollow metallic structure is filled by a porous structure.

17. The seal of claim 16, wherein the porous structure is a ductile metal.

18. The seal of claim 16, wherein the porous structure is a ceramic powder.

19. The seal of claim 15, wherein the hollow metallic structure is self-supporting.

20. A method for separating fuel gas from oxidant gas using a metallic barrier, comprising the steps of:
providing a metallic plate having first and second surfaces;
exposing the fuel gas to the first surface of the metallic plate;
exposing the oxidant gas to the second surface of the metallic plate;
forming an adherent oxide layer on the second surface at a metal-metal oxide interface; and
diffusing a portion of the fuel gas from the first surface into the metallic plate for modifying an oxidation environment at the metal-metal oxide interface to dynamically stabilize a thickness of the adherent oxide layer.

21. The method of claim 20, wherein the fuel gas is hydrogen.

22. The method of claim 20, wherein the metallic substance is selected from the group consisting of: nickel, copper and cobalt.
